(19) United States
(12) Patent Application Publication
(10) Pub. No.: US 2026/0113561 A1
(43) Pub. Date: Apr. 23, 2026

(54) EARPHONES

(71) Applicant: SHENZHEN SHOKZ CO., LTD., Shenzhen (CN)

(72) Inventors: Chaowu LI, Shenzhen (CN); Qianwen NIE, Shenzhen (CN); Chong WANG, Shenzhen (CN); Xu ZHANG, Shenzhen (CN)

(73) Assignee: SHENZHEN SHOKZ CO., LTD., Shenzhen (CN)

(21) Appl. No.: 19/426,007

(22) Filed: Dec. 18, 2025

Related U.S. Application Data
(63) Continuation of application No. PCT/CN2024/095598, filed on May 27, 2024.

(51) Int. Cl. H04R 1/10; H04R 1/06

(52) U.S. Cl. CPC H04R 1/1041; H04R 1/06; H04R 1/105

(57) ABSTRACT

The present disclosure relates to an earphone. The earphone comprises a housing assembly including a first housing, a deformation member, and a sensor. The first housing includes a first side wall portion and a second side wall portion that are disposed opposite to and spaced apart from each other. When subjected to an opposing compression force applied along a spacing direction, at least one of the first side wall portion or the second side wall portion deforms, and the first side wall portion and the second side wall portion jointly compress the deformation member such that the deformation member bends laterally in the spacing direction. The sensor is disposed in a bending region of the deformation member, and generates an electrical signal when a bending degree of the bending region is greater than a preset bending threshold.

### CROSS-REFERENCE TO RELATED APPLICATION

The application is a Continuation of International Application No. PCT/CN2024/095598 filed on May 27, 2024, the contents of which are entirely incorporated herein by reference.

### TECHNICAL FIELD

This present disclosure relates to a technical field of electronic devices, and in particular, to earphones.

### BACKGROUND

With the increasing proliferation of electronic devices, the electronic devices have become indispensable social and entertainment tools in people's daily lives, and people's requirements for the electronic devices are also increasing. The electronic devices (e.g., earphones, smart glasses) have also been widely used in people's daily life, which can be used in conjunction with terminal devices (e.g., mobile phones, computers, etc.) to provide users with an auditory feast. Existing earphones generate control instructions through mechanical buttons. However, with the increase in control functions of the earphones, the simple mechanical buttons are no longer sufficient to meet the expanded control requirements.

### SUMMARY

The present disclosure provides an earphone. The earphone includes a housing assembly including a first housing. The first housing includes a first side wall portion and a second side wall portion that are disposed opposite to and spaced apart from each other. The earphone is also provided with a deformation member and a sensor. The deformation member is disposed between the first side wall portion and the second side wall portion. When outer sides of the first side wall portion and the second side wall portion are subjected to an opposing compression force applied along a spacing direction between the first side wall portion and the second side wall portion, at least one of the first side wall portion or the second side wall portion deforms, and the first side wall portion and the second side wall portion jointly compress the deformation member such that the deformation member bends laterally in the spacing direction. The sensor is disposed in a bending region of the deformation member, and generates an electrical signal when a bending degree of the bending region is greater than a preset bending threshold.

In some embodiments, the deformation member has a plate-shaped region. The plate-shaped region is configured to laterally bend toward a main surface of the plate-shaped region under a compression action of the first side wall portion and the second side wall portion. The sensor is disposed on the plate-shaped region.

In some embodiments, the deformation member is a circuit board. The sensor is disposed on the circuit board. The circuit board is provided with a sensing control circuit electrically connected to the sensor. The sensing control circuit is configured to perform a corresponding control function based on the electrical signal.

In some embodiments, a main surface of the circuit board is disposed along the spacing direction. The first side wall portion and the second side wall portion compress opposite side edges of the circuit board under an action of the opposing compression force such that the main surface of the circuit board laterally bends. The sensor is disposed on the main surface of the circuit board.

In some embodiments, in a natural state and along the spacing direction, a first gap is maintained between at least one of the first side wall portion or the second side wall portion and a corresponding adjacent side edge of the circuit board.

In some embodiments, the first gap is greater than an amount of deformation of the first side wall portion and the second side wall portion when the opposing compression force is a first pressure threshold, and less than an amount of deformation of the first side wall portion and the second side wall portion when the opposing compression force is a second pressure threshold. The first pressure threshold is not less than 0.5 newtons. The second pressure threshold is within a range from 1 newton to 5 newtons.

In some embodiments, the housing assembly includes a second housing that cooperates with the first housing along a preset cooperation direction, the cooperation direction intersecting with the spacing direction. The second housing includes a third side wall portion and a fourth side wall portion that are spaced apart along the spacing direction. The third side wall portion and the fourth side wall portion are inserted into a space between the first side wall portion and the second side wall portion along the cooperation direction and partially overlap with the first side wall portion and the second side wall portion, respectively. In a natural state and along the spacing direction, a second gap is maintained between the first side wall portion and the adjacent third side wall portion, a second gap is maintained between the second side wall portion and the adjacent fourth side wall portion, each second gap being greater than the first gap.

In some embodiments, the first housing further includes a first top wall portion connecting the first side wall portion and the second side wall portion. The second housing further includes a second top wall portion connecting the third side wall portion and the fourth side wall portion. The first top wall portion and the second top wall portion are disposed opposite to each other and spaced apart along the cooperation direction. The circuit board is located between the first top wall portion and the second top wall portion. Along the cooperation direction, one side edge of the circuit board further overlaps with an overlapping portion between the first side wall portion and the third side wall portion, and the other side edge of the circuit board further overlaps with an overlapping portion between the second side wall portion and the fourth side wall portion.

In some embodiments, the earphone further includes a circuit board disposed in the housing assembly. The deformation member is separated from the circuit board. The circuit board includes a sensing control circuit electrically connected to the sensor. The sensing control circuit is configured to perform a corresponding control function based on the electrical signal.

In some embodiments, along the spacing direction, the deformation member includes an arched portion and two abutment portions, the two abutment portions are respectively connected to two ends of the arched portion and extend away from the arched portion. The arched portion is arranged in an arch from the two ends of the arched portion along a direction perpendicular to the spacing direction. The sensor is disposed on the arched portion. The two abutment portions abut against the first side wall portion and the second side wall portion, respectively.

In some embodiments, along the spacing direction, the sensor is located at a middle portion of the arched portion.

In some embodiments, the deformation member is formed by bending a plate or a sheet. The arched portion is arranged in a rectangular arch shape, a U-shape, or a C-shape.

In some embodiments, the earphone further includes a speaker disposed in the housing assembly. A main surface of the circuit board is disposed to overlap with the speaker along an axial direction of the speaker. The deformation member is disposed on a side of the speaker along a radial direction of the speaker. A main surface of the deformation member and the main surface of the circuit board intersect with each other.

In some embodiments, the earphone further includes an ear-hook portion connected to the housing assembly. The ear-hook portion is configured to position the housing assembly anterior to a user's tragus in a wearing state, and the deformation member is disposed at a side of the speaker near the ear-hook portion along the radial direction of the speaker.

In some embodiments, the earphone further includes a speaker disposed in the housing assembly. A main surface of the circuit board and a main surface of the deformation member overlap with the speaker along an axial direction of the speaker, and overlap with each other.

In some embodiments, the deformation member serves as a first top wall portion of the first housing that connects the first side wall portion and the second side wall portion; or the deformation member serves as a second housing cooperating with the first housing.

In some embodiments, the housing assembly further includes a second housing cooperating with the first housing. The earphone further includes a speaker disposed in the housing assembly and an ear-hook portion connected to the housing assembly. The ear-hook portion is configured to position the housing assembly anterior to a user's tragus in a wearing state. The speaker is substantially or entirely located within the first housing.

In some embodiments, the housing assembly includes a connection end connected to the ear-hook portion and a free end away from the connection end. The housing assembly has a length direction, a width direction, and a thickness direction that are orthogonal to each other. The length direction is defined as a direction from the free end toward or away from the connection end, and the thickness direction is defined as a direction toward or away from the user's auricle in the wearing state. The first side wall portion and the second side wall portion are spaced apart from each other along the width direction.

In some embodiments, a dimension of the first side wall portion along the length direction is greater than a dimension of the first side wall portion along the thickness direction, and a dimension of the second side wall portion along the length direction is greater than a dimension of the second side wall portion along the thickness direction.

Beneficial effects of the present disclosure are as follows. By applying the opposing compression force to the first housing, a touch operation is transmitted to the sensor, thereby effectively enhancing the touch accuracy of the earphone and improving the anti-interference performance of a touch function of the earphone. Furthermore, the sensor is disposed on the bending region of the deformation member, so that the sensor can directly perceive deformation of the deformation member to receive the touch operation applied by a user on the first side wall portion and the second side wall portion. Under the same sensing accuracy, the sensor can perceive finer deformation of the deformation member, thereby effectively improving the touch sensitivity of the earphone and reducing manufacturing cost of the earphone.

### BRIEF DESCRIPTION OF THE DRAWINGS

In order to more clearly illustrate the technical solutions in the embodiments of the present disclosure or the prior art, the following will briefly introduce the drawings that need to be used in the description of the embodiments or the prior art. Obviously, the accompanying drawings in the following description are merely some embodiments of the present disclosure. For those of ordinary skill in the art, other drawings may also be obtained according to these drawings without creative work.

FIG. 1 is a schematic diagram illustrating an exemplary anterior side profile of an ear of a user according to some embodiments of the present disclosure;

FIG. 2 is a schematic diagram illustrating an exemplary structure of an earphone according to one embodiment provided by the present disclosure;

FIG. 3 is a schematic diagram illustrating the earphone as shown in FIG. 2 in a wearing state;

FIG. 4 is a schematic diagram illustrating an exploded structure of the earphone according to an embodiment in which a circuit board serves as a deformation member in the earphone as shown in FIG. 2;

FIG. 5 is a schematic diagram illustrating an exploded structure of the earphone according to an embodiment in which a component separated from a circuit board serves as a deformation member in the earphone as shown in FIG. 2;

FIG. 6 is a schematic diagram illustrating an exploded structure of the earphone according to an embodiment in which a second housing serves as a deformation member in the earphone as shown in FIG. 2;

FIG. 7 is a schematic diagram illustrating a structure of a circuit board in FIG. 2 according to one embodiment of the present disclosure;

FIG. 8 is a schematic diagram illustrating a sectional structure of a core module along a cutting direction A1-A1 according to an embodiment in which a circuit board serves as a deformation member in the earphone as shown in FIG. 2;

FIG. 9 is a schematic diagram illustrating a partial structure B of the core module as shown in FIG. 8;

FIG. 10 is a schematic diagram illustrating a structure of a core module as shown in FIG. 5 without a second housing; and

FIG. 11 is a schematic diagram illustrating a sectional structure of a core module along a cutting direction A2-A2 according to an embodiment in which a second housing serves as a deformation member in the earphone as shown in FIG. 2.

### DETAILED DESCRIPTION

The following will clearly and completely describe the technical solutions in the embodiments of the present disclosure with reference to the accompanying drawings in the embodiments of the present disclosure. Obviously, the described embodiments are only a part of the embodiments of the present disclosure, and not all of them. Based on the embodiments of the present disclosure, all other embodiments obtained by persons of ordinary skill in the art without making creative efforts belong to the scope of protection of the present disclosure.

In the present disclosure, a term “embodiment” means that a specific feature, structure, or characteristic described in connection with the embodiment may be included in at least one embodiment of the present disclosure. The persons of ordinary skill in the art explicitly and implicitly understand that the embodiments described in the present disclosure can be combined with other embodiments.

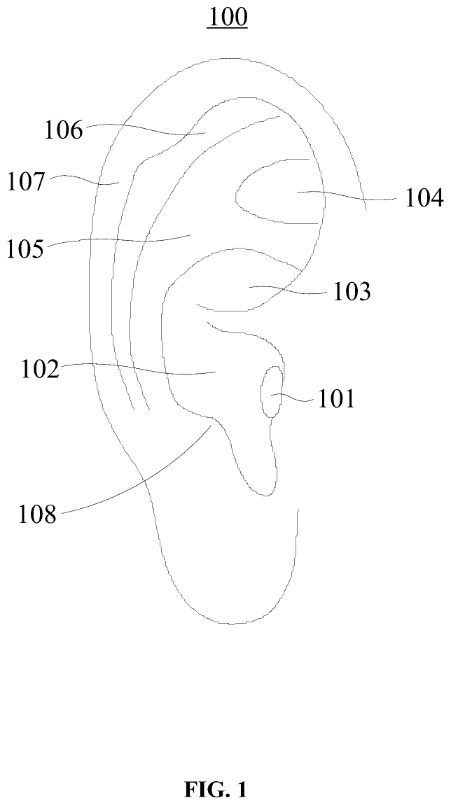

Referring to FIG. 1, an ear 100 of a user may include physiological parts, such as an external ear canal 101, a concha cavity 102, a cymba conchae 103, a triangular fossa 104, an antihelix 105, a scapha 106, a helix 107, a tragus 108, etc. Although the external ear canal 101 has a certain depth and extends to an eardrum of the ear, for the convenience of description and in combination with FIG. 1, unless otherwise specified, the external ear canal 101 refers to an entrance (i.e., an ear hole) of the external ear canal 101 that is away from the tympanic membrane in the present disclosure. Further, the physiological parts (e.g., the concha cavity 102, the cymba conchae 103, the triangular fossa 104, etc.) have a certain volume and depth, and the concha cavity 102 is directly connected to the external ear canal 101, which can be simply regarded as that the aperture is located at a bottom of the concha cavity 102.

Furthermore, different users may have individual differences, resulting in different dimensional differences (e.g., different shapes, sizes, etc.) of ears. For the convenience of description and to reduce (or even eliminate) the individual differences between the users, a simulator including a head and (left and right) ears of the head may be produced based on the ANSI: S3.36, S3.25 and IEC: 60318-7 standards, such as a GRAS 45BC KEMAR, a HEAD Acoustics system, a B&K 4128 series, or a B&K 5128 series, so as to present a wearing scenario of the earphone 10 by a majority of the users. Merely by way of example, taking a GRAS KEMAR as an example, the simulator of the ear may be any one of a GRAS 45AC, a GRAS 45BC, a GRAS 45CC, or a GRAS 43AG. As another example, taking the HEAD Acoustics as an example, the simulator of the ear may be any one of HMS II.3, HMS II.3 LN, or HMS II.3LN HEC. Therefore, in the present disclosure, descriptions such as “the user wears an earphone 10,” “the earphone 10 is in a wearing state,” “in the wearing state,” etc., may refer to that the earphone 10 described in the present disclosure is worn on the ear of the simulator. Of course, due to the individual differences between different users, there may be certain differences when the earphone 10 is worn by different users and when the earphone 10 is worn on the ear of the simulator, but the differences should be tolerated.

It should be noted that in fields of medicine, anatomy, etc., three basic sections (a sagittal plane, a coronal plane, and a horizontal plane) and three basic axes (a sagittal axis, a coronal axis, and a vertical axis) of a human body may be defined. The sagittal plane refers to a section along an anterior-posterior direction of the body and perpendicular to the ground, which divides the body into left and right parts. The coronal plane refers to a section along a left-right direction of the body and perpendicular to the ground, which divides the body into anterior and posterior parts. The horizontal plane refers to a section along an up-down direction of the body and parallel to the ground, which divides the body into upper and lower parts. Correspondingly, the sagittal axis refers to an axis along the anterior-posterior direction of the body and perpendicular to the coronal plane, the coronal axis refers to an axis along the left-right direction of the body and perpendicular to the sagittal plane, and the vertical axis VA refers to an axis along the upper-lower direction of the body and perpendicular to the horizontal plane. Furthermore, an “anterior side of the ear” described in the present disclosure is a concept relative to a “posterior side of the ear”, the anterior side refers to a side of the ear away from the head, and the posterior side refers to a side of the ear toward the head, and the anterior side and the posterior side are defined with respect to the ear of the user. When observing the ear of the simulator along a direction at which the coronal axis of the human body is located, a schematic diagram of an anterior side profile of the ear shown in FIG. 1 may be obtained.

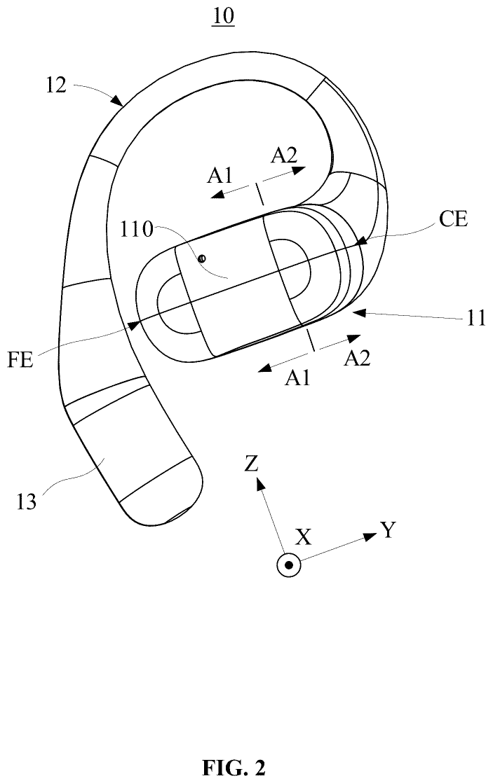

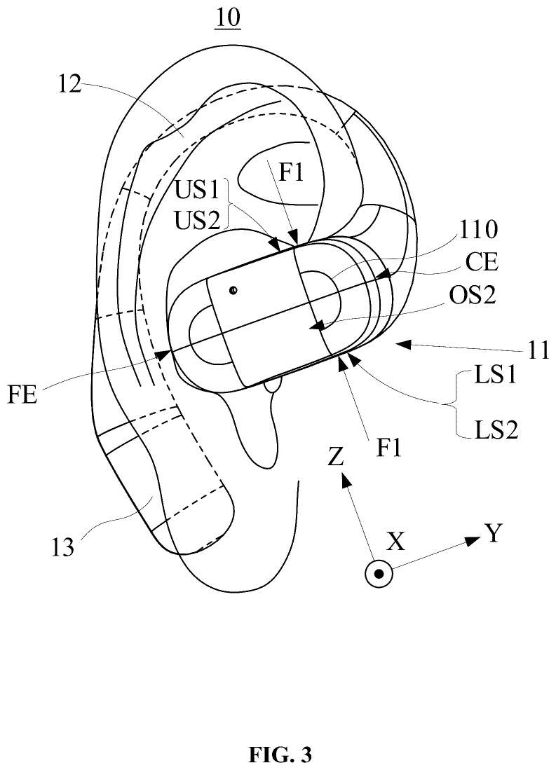

Merely by way of example, referring to FIGS. 2 to 6, the earphone 10 may include a core module 11 and an ear-hook portion 12 connected to the core module 11. The core module 11 is located on the anterior side of the ear in the wearing state, and at least a portion of the ear-hook portion 12 is located on the posterior side of the ear in the wearing state, so that the earphone 10 is hung on the ear in the wearing state. The core module 11 may include a connection end CE connected to the ear-hook portion 12 and a free end FE that is not connected to the ear-hook portion 12. Furthermore, the core module 11 may be configured to not block the external ear canal in the wearing state, so that the earphone 10 serves as an “open earphone. ” Due to individual differences between different users, when the earphone 10 is worn by different users, the core module 11 may partially cover the external ear canal, but the external ear canal is still not completely blocked.

Optionally, in some embodiments, the core module 11 includes a housing assembly 110 (in some embodiments of the present disclosure, the housing assembly is also referred to as the core module), a speaker 111, and a circuit board 112. Furthermore, the speaker 111 and the circuit board 112 may be disposed in a stacked manner in the housing assembly 110, so that space utilization inside the core module 11 can be effectively improved, and an overall dimension of the earphone 10 can be optimized. Specifically, by disposing the speaker 111 and the circuit board 112 in the stacked manner without changing the dimension of the core module 11, a board surface of the circuit board 112 can be larger and more complete without interference from the speaker 111, thereby facilitating processing, and effectively increasing an area of the board surface of the circuit board 112. Therefore, more circuits (e.g., the main control circuit, the sensing control circuit, etc.) can be integrated into the circuit board 112. In some embodiments, the circuit board 112 is integrally provided with at least one of circuits, such as, the main control circuit, the sensing control circuit, etc. Preferably, in the present embodiment, the circuit board 112 is at least integrally provided with the main control circuit of the earphone 10 and the sensing control circuit for connecting to the sensor 15. The speaker 111 refers to a component that is configured to convert an electrical signal into a corresponding sound signal under control of the circuit board 112. In the present embodiment, the speaker 111 is an air-conduction speaker 111. In other embodiments, the speaker 111 may also be set as a bone-conduction speaker 111.

It should be noted that the speaker 111 and the circuit board 112 being disposed in the stacked manner in the housing assembly 110 refers to that the speaker 111 and the circuit board 112 are spatially arranged up and down along an axial direction z1 of the speaker 111.

Optionally, in some embodiments, the earphone 10 further includes a battery assembly connected to an end of the ear-hook portion 12 away from the core module 11. The battery assembly includes a battery housing 13, and a battery coupled to the core module 11 is disposed in the battery housing 13. A positive projection of the battery housing 13 on a reference plane partially overlaps with a positive projection of the free end FE on the same reference plane. Therefore, when at least a portion of the free end FE is inserted into the cavum conchae, the battery housing 13 may support the ear from the posterior side of the ear, thereby improving the stability of the earphone 10 in the wearing state.

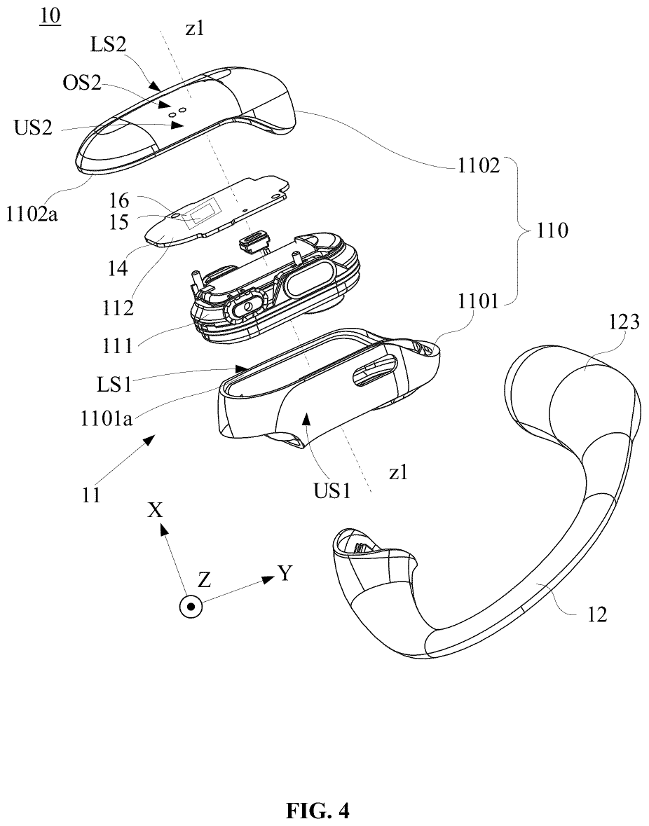

Optionally, as shown in FIGS. 4 to 6, in some embodiments, the earphone 10 further includes the housing assembly 110, a deformation member 14, and a sensor 15 disposed on the deformation member 14. The deformation member 14 is provided with a bending region, and the bending region bends laterally in a spacing direction when subjected to an opposing compression force F1 applied along the spacing direction. As used herein, an opposing compression force is a pair of counter-directed forces externally applied to the bending region. The sensor 15 is disposed in the bending region, so as to generate an electrical signal when a bending degree of the bending region is greater than a preset bending threshold, and transmit the electrical signal to a corresponding component (e.g., the circuit board 112) of the earphone 10. Therefore, the circuit board 112 performs a corresponding control function based on the electrical signal, thereby controlling the earphone 10 to perform a corresponding function (e.g., switching a track, pausing playback, starting playback, etc.) of the earphone 10.

It should be noted that the bending region is a portion of the deformation member 14, and the bending region refers to a region on the deformation member 14 that bends laterally and has a bending amount greater than other portions of the deformation member 14 when subjected to the opposing compression force F1. In the natural state, the bending region may be in any structural shape.

Optionally, in some embodiments, the preset bending threshold may be set, and the electrical signal generated by the sensor 15 when the bending degree of the bending region is greater than the preset bending threshold may be served as the electrical signal for triggering the earphone function, so that the circuit board 112 can better avoid electrical signals generated due to an accidental touch by a user, thereby effectively enhancing the control accuracy of the earphone 10 and improving the anti-interference performance of the control function of the earphone 10. For example, in some embodiments, the sensor 15 generates an electrical signal of a corresponding signal level based on the deformation amount of the deformation member 14. When the signal level of the electrical signal does not exceed the preset threshold (when the signal level is less than or equal to the preset threshold, it indicates that the electrical signal is a signal caused by an accidental touch operation), the control function is not performed by the circuit board 112. Specifically, the preset bending threshold may be determined by a statistical analysis manner, or may be determined by the user according to the user's usage habit.

Furthermore, as shown in FIGS. 4 to 6, in some embodiments, the housing assembly 110 includes the first housing 1101. The first housing 1101 includes a first side wall portion US1 and a second side wall portion LS1 that are disposed opposite to and spaced apart from each other. The opposing compression force F1 are applied to outer sides of the first side wall portion US1 and the second side wall portion LS1 along the spacing direction between the first side wall portion US1 and the second side wall portion LS1, so that the first side wall portion US1 and the second side wall portion LS1 deform, and indirectly or directly transmit the compression force or a pressing force to the deformation member 14. Therefore, the deformation member 14 deforms and the deformation is detected by the sensor 15. The first housing 1101 serves as an outer housing of the earphone 10, i.e., an overall structural support member of the earphone 10. Therefore, when the first housing 1101 servers as the structural support member, and a force applied to the first side wall portion US1 and/or the second side wall portion LS1 is relatively small, a structural strength of the first housing 1101 is sufficient to resist the force, thereby effectively reducing a probability that the first side wall portion US1 and/or the second side wall portion LS1 deform due to the accidental touch operation (e.g., a slight collision, a slight extrusion, etc.). Therefore, a risk that the deformation member 14 deforms due to the accidental touch operation (e.g., the slight collision, the slight extrusion, etc.) can be effectively reduced, thereby further effectively enhancing the touch accuracy of the earphone 10 and improving the anti-interference capability of a touch function of the earphone 10.

It should be noted that when the outer sides of the first side wall portion US1 and the second side wall portion LS1 are subjected to the opposing compression force F1 along the spacing direction between the first side wall portion US1 and the second side wall portion LS1, at least one of the first side wall portion US1 or the second side wall portion LS1 deforms, so that at least a portion of the first side wall portion US1 and at least a portion of the second side wall portion LS1 present a small displacement of approaching each other along the spacing direction, thereby transmitting the compression force to the deformation member 14 by abutting against or pulling the deformation member 14. For example, in some embodiments, when the outer sides of the first side wall portion US1 and the second side wall portion LS1 are subjected to the opposing compression force F1 applied along the spacing direction, each of the first side wall portion US1 and the second side wall portion LS1 deforms with the corresponding displacement under the opposing compression force F1, so that the first side wall portion US1 and the second side wall portion LS1 as a whole present the small displacement of approaching each other along the spacing direction. As another example, in some embodiments, when the outer sides of the first side wall portion US1 and the second side wall portion LS1 are subjected to the opposing compression force F1 applied along the spacing direction, only one of the first side wall portion US1 or the second side wall portion LS1 deforms with the corresponding displacement, but the first side wall portion US1 and the second side wall portion LS1 as a whole still present the small displacement of approaching each other along the spacing direction. Certainly, in the present embodiment, the first side wall portion US1 and the second side wall portion LS1 are set such that when subjected to the opposing compression force F1, each of the first side wall portion US1 and the second side wall portion LS1 deforms with the corresponding displacement, and deformation displacement amounts of the first side wall portion US1 and the second side wall portion LS1 are approximately equal. Therefore, the comfort of the user when pressing the earphone 10 can be effectively improved, and a situation where the earphone 10 is subjected to an imbalance force when the user applies an opposing pressing force to the earphone 10 can also be effectively prevented, thereby avoiding the earphone 10 from falling off from the user's ear.

Furthermore, in some embodiments, the sensor 15 is directly disposed on the deformation member 14, and is located in the bending region of the deformation member 14. For example, a resistance sensor is directly adhered to a surface of the bending region. In this way, the sensor 15 can directly perceive the deformation of the deformation member 14 to receive a touch operation applied by the user on the first side wall portion US1 and the second side wall portion LS1. Under the same sensing accuracy, the sensor 15 can perceive finer deformation of the deformation member 14, thereby effectively improving the touch sensitivity of the earphone 10 and effectively reducing the manufacturing cost of the earphone 10.

Preferably, in some embodiments, the housing assembly 110 serves as a core housing of the core module 11. Since the core module 11 is located on the anterior side of the ear when the earphone 10 is in the wearing state, compared with earphone components (e.g., the ear-hook portion 12) located on the posterior side of the ear, a spatial position where the core module 11 is located in the wearing state is more convenient for the user to operate the earphone 10. Therefore, the housing assembly 110 is set as a triggering member for triggering the deformation of the deformation member 14 to control functions of the earphone 10, thereby effectively improving the convenience of the touch operation of the earphone 10. Furthermore, in some embodiments, in an ear-hook earphone, the core module 11 is usually the largest portion in overall structural dimensions of the earphone 10. The housing assembly 110 is set as the triggering member for triggering the lateral bending of the deformation member 14, which conforms to an operating habit of a human hand, thereby effectively improving the convenience of the touch operation of the earphone 10. Optionally, in some embodiments, along a thickness direction X, the spacing distance between the first side wall portion US1 and the second side wall portion LS1 is less than or equal to a maximum thickness dimension of the housing assembly 110. In this way, the convenience of the touch operation of the earphone 10 can be effectively improved. Preferably, in some embodiments, along the thickness direction X, the spacing distance between the first side wall portion US1 and the second side wall portion LS1 is equal to the maximum thickness dimension of the housing assembly 110.

Optionally, in some embodiments, the spacing direction is defined as an operating direction in which an opposing pressure may be applied to two opposite sides of the housing assembly 110 by a user in the wearing state of the earphone 10. Specifically, the housing assembly 110 includes a length direction Y, a width direction Z, and the thickness direction X that are orthogonal to each other. The length direction Y is defined as a direction from the free end FE toward or away from the connection end CE, and the thickness direction X is defined as a direction toward or away from an auricle in the wearing state. In the present embodiment, the spacing direction is set to be parallel to the width direction Z. That is, the first side wall portion US1 and the second side wall portion LS1 are side walls located at two sides of the first housing 1101 along the thickness direction X. In this way, in the wearing state of the earphone 10, the first side wall portion US1 and the second side wall portion LS1 are not completely shielded by parts (e.g., the ears, the head, etc.) of the user, thereby facilitating the user to press the first side wall portion US1 and the second side wall portion LS1 to control the earphone function of the earphone 10.

Optionally, in some embodiments, a dimension of the first side wall portion US1 along the length direction Y is greater than a dimension of the first side wall portion US1 along the thickness direction X, and a dimension of the second side wall portion LS1 along the length direction Y is greater than a dimension of the second side wall portion LS1 along the thickness direction X, so that the first side wall portion US1 and the second side wall portion LS1 are easier to deform, thereby effectively improving pressure-control comfort of the earphone 10.

Optionally, as shown in FIGS. 4 to 6, in some embodiments, the housing assembly 110 further includes the second housing 1102 that cooperates with the first housing 1101 along a preset cooperation direction, and the cooperation direction intersects with the spacing direction, thereby effectively improving the assembly convenience of the earphone 10. In the present embodiment, the cooperation direction is parallel to the thickness direction X.

Furthermore, as shown in FIGS. 4 to 6, in some embodiments, the first housing 1101 includes side walls and a first top wall portion OS1, and the second housing 1102 includes side walls and a second top wall portion OS2 connected to the side walls of the second housing 1102. The first side wall portion US1 and the second side wall portion LS1 are two side wall portions of the first housing 1101 that are spaced apart from each other along the spacing direction.

Optionally, in some embodiments, an end of a side wall of the first housing 1101 away from the first top wall portion OS1 is provided with a first ring portion 1101a that is recessed outward from an inner side of the side wall of the first housing 1101, and an end of a side wall of the second housing 1102 away from the second top wall portion OS2 is provided with a second ring portion 1102a that is recessed inward from an outer side of the side wall of the second housing 1102. Along the cooperation direction, the second ring portion 1102a is inserted into an inner side of the first ring portion 1101a, and a gluing gap (i.e., the gluing gap includes a second gap Jx1 in some embodiments herein) is reserved between the first ring portion 1101a and the second ring portion 1102a at least along the spacing direction. The gluing gap is configured to connect and fix the first ring portion 1101a and the second ring portion 1102a by a gluing manner, thereby effectively improving the connection stability between the first housing 1101 and the second housing 1102. In addition, the first housing 1101 and the second housing 1102 cooperate with each other through the first ring portion 1101a and the second ring portion 1102a, so that an outer surface of the side wall of the first housing 1101 and an outer surface of the side wall of the second housing 1102 achieve a smooth transition connection, thereby effectively improving the appearance of the earphone 10. Optionally, in some embodiments, the earphone 10 includes an elastic sealing adhesive, and the elastic sealing adhesive is disposed in the gluing gap and is configured to connect and fix the first housing 1101 and the second housing 1102.

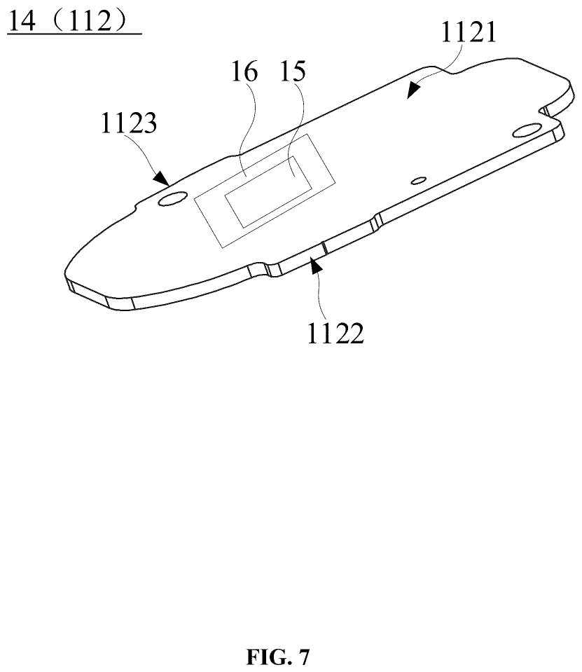

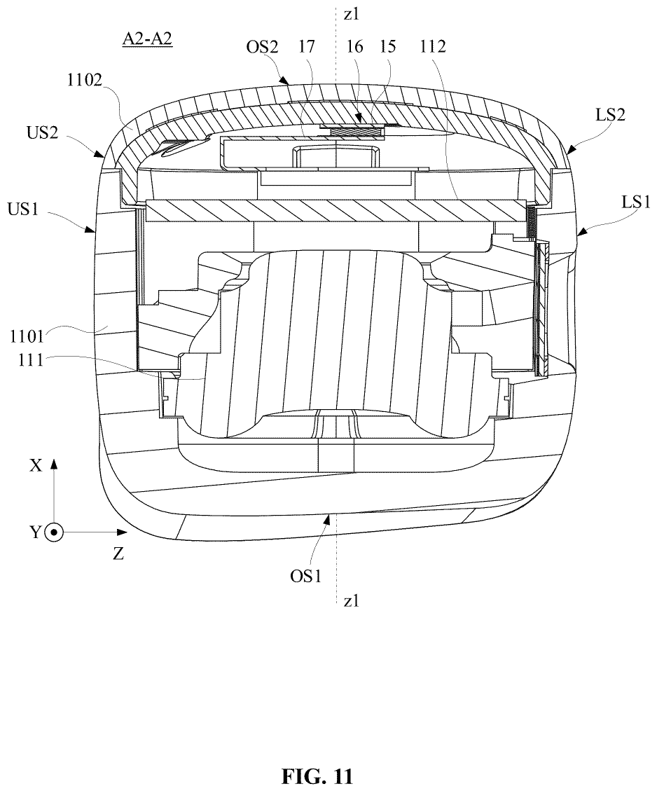

Optionally, as shown in FIG. 7 and FIG. 11, in some embodiments, the deformation member 14 has a plate-shaped region 16. When the outer sides of the first side wall portion US1 and the second side wall portion LS1 are subjected to the opposing compression force, the plate-shaped region 16 receives a compression or pressing force indirectly or directly transmitted to the deformation member 14, so as to laterally bend. The sensor 15 is disposed on the plate-shaped region 16. It should be noted that the plate-shaped region 16 refers to a partial region of the deformation member 14 that is arranged in a plate shape, and does not directly limit an overall structure of the deformation member 14 to be in the plate shape. In other words, the overall structure of the deformation member 14 may be in a rod shape, a bar shape, a plate shape, or the like. Therefore, by providing the plate-shaped region 16 on the deformation member 14, the deformation member 14 can better perceive an opposing force applied by the user to the first side wall portion US1 and the second side wall portion LS1 and generate the corresponding deformation, so that the sensor 15 can better receive a touch operation signal of the user, thereby effectively improving the control sensitivity of the earphone 10. The bending region includes the plate-shaped region 16. In other words, the plate-shaped region 16 is located in the bending region of the deformation member 14, and an area of the plate-shaped region 16 is less than or equal to an area of the bending region.

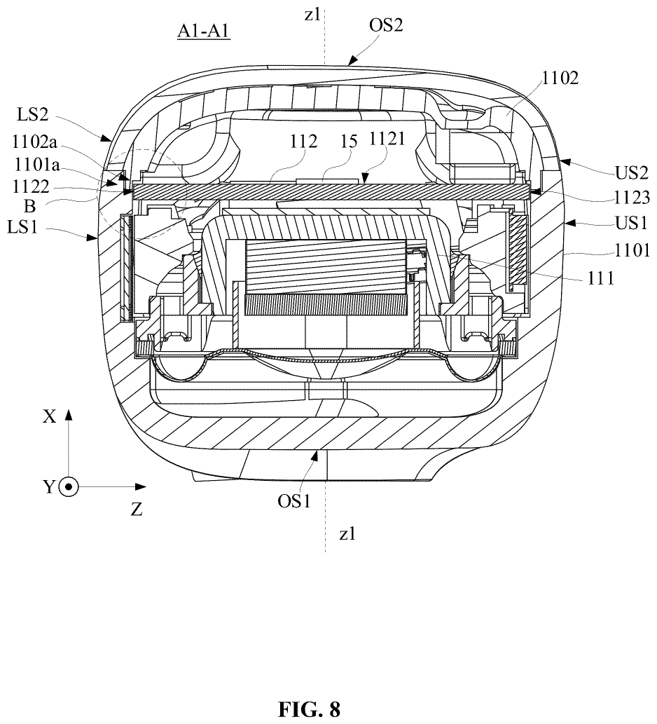

Optionally, as shown in FIG. 4, FIG. 7, and FIG. 8, in some embodiments, the deformation member 14 may be a circuit board 112, and the sensor 15 is directly disposed on the circuit board 112. The circuit board 112 is provided with the sensing control circuit electrically connected to the sensor 15, and the sensing control circuit is configured to perform a corresponding control function based on the electrical signal. In this way, the sensor 15 can be directly connected to the sensing control circuit through the circuit board 112. Furthermore, the circuit board 112 serves as the circuit board of the earphone 10 for circuit layout, also serves as the deformation member 14 for transmitting a touch signal of the user to the sensor 15, thereby effectively simplifying internal wiring and internal structure of the earphone 10, and effectively improving the space utilization of the earphone 10.

Optionally, as shown in FIG. 8, in some embodiments, side edges (i.e., a side edge 1122 and a side edge 1123) of the circuit board 112 along the spacing direction abut against inner walls of the first side wall portion US1 and the second side wall portion LS1, respectively. Alternatively, the side edges are spaced apart by a gap from the inner walls. The first side wall portion US1 and the second side wall portion LS1 compress opposite the side edges (i.e., the side edge 1122 and the side edge 1123) of the circuit board 112 under an action of the opposing compression force F1 such that a main surface 1121 of the circuit board 112 laterally bends, and the sensor 15 is disposed on the main surface 1121 of the circuit board 112. In some embodiments, an overall structure of the circuit board 112 is in a plate shape. The main surface 1121 of the circuit board 112 serves as a plate surface of the circuit board 112, and the main surface 1121 of the circuit board 112 is disposed at a preset angle with respect to the spacing direction. The preset angle is greater than or equal to 0° and less than or equal to 5°. For example, the preset angle may be 5°. In this way, the circuit board 112 deforms under the compression of the first side wall portion US1 and the second side wall portion LS1 more easily, thereby effectively improving the control sensitivity of the earphone 10.

Specifically, in some embodiments, in the natural state, the side edges (i.e., the side edge 1122 and the side edge 1123) of the circuit board 112 along the spacing direction abut against the inner walls of the first side wall portion US1 and the second side wall portion LS1. In this way, when the first side wall portion US1 and the second side wall portion LS1 are subjected to the opposing compression force F1, the first side wall portion US1 and the second side wall portion LS1 can transmit the opposing compression force F1 to the circuit board 112 at a first moment, thereby effectively improving a control response speed of the earphone 10, and further effectively improving usage experience of the user.

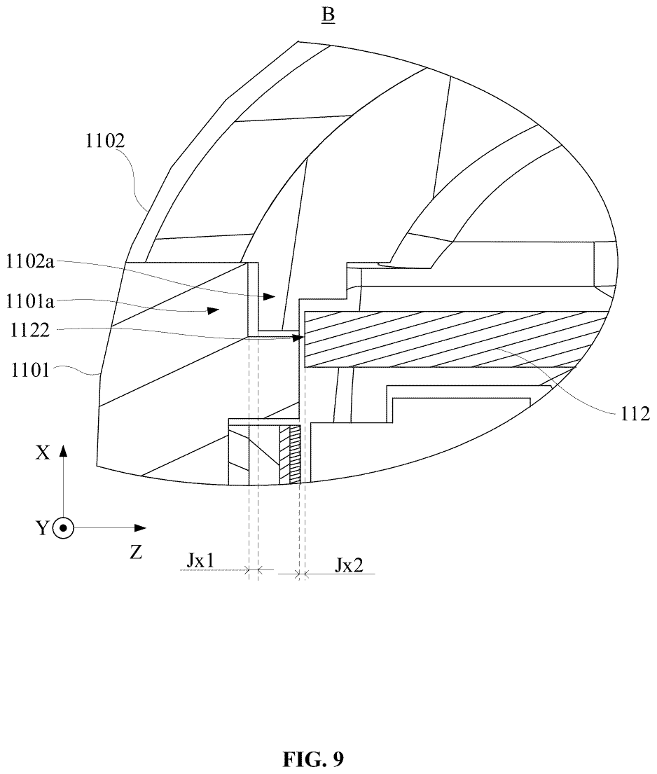

Specifically, as shown in FIG. 9, in some embodiments, in the natural state and along the spacing direction, a first gap Jx2 is maintained between at least one of the first side wall portion US1 or the second side wall portion LS1 and a corresponding adjacent side edge of the circuit board 112. Specifically, along the spacing direction, the circuit board 112 includes the two side edges (i.e., the side edge 1122 and the side edge 1123) disposed opposite to each other. The side edge 1123 is spaced apart from the first side wall portion US1 by the first gap Jx2, and the other side edge 1122 is spaced apart from the second side wall portion LS1 by the first gap Jx2. In this way, in the natural state, the first side wall portion US1 and the second side wall portion LS1 can maintain a distance without contact, thereby preventing the circuit board 112 from deforming due to the accidental touch operation applied by the user to the first side wall portion US1 and the second side wall portion LS1. Therefore, a situation where the earphone functions that do not conform to an intention of the user is randomly performed by the earphone 10 can be avoided, thereby further effectively enhancing the control accuracy of the earphone 10 and improving the anti-interference capability of the control function of the earphone 10. The first gap Jx2 is a minimum distance from the inner side of the first side wall portion US1 to the circuit board 112 (i.e., a distance from the inner side of the first side wall portion US1 to the side edge 1123), and the first gap Jx2 is also a minimum distance from the inner side of the second side wall portion LS1 to the circuit board 112 (i.e., a distance from the inner side of the second side wall portion LS1 to the side edge 1122). That is, each of the minimum distance from the inner side of the first side wall portion US1 to the circuit board 112 and the minimum distance from the inner side of the second side wall portion LS1 to the circuit board 112 is set to be the first gap Jx2, so that the force stability of the first side wall portion US1 and the second side wall portion LS1 can be effectively ensured when the first side wall portion US1 and the second side wall portion LS1 are subjected to the opposing compression force. Therefore, the situation where the earphone 10 is subjected to the imbalance force when the user applies the opposing pressing force to the earphone 10 can be effectively prevented, thereby avoiding the earphone 10 from falling off from the user's ear.

Of course, in some embodiments, the minimum distance between the inner side of the first side wall portion US1 and the circuit board 112 and the minimum distance between the second side wall portion LS1 and the circuit board 112 may also be different. For example, one of the first side wall portion US1 or the second side wall portion LS1 may directly abut against the circuit board 112, and the other one of the first side wall portion US1 or the second side wall portion LS1 may be spaced apart from the circuit board 112 by the first gap Jx2. In this way, even if the accidental touch operation is applied by the user to the earphone 10, the other one of the first side wall portion US1 or the second side wall portion LS1 can still maintain a distance from the circuit board 112 through the first gap Jx2, thereby preventing the first side wall portion US1 and the second side wall portion LS1 from simultaneously compressing the circuit board 112 to cause the deformation of the circuit board 112, and still enhancing the control accuracy of the earphone 10 and improving the anti-interference capability of the control functions to a certain extent. In other words, in the natural state and along the spacing direction, as long as one of the first side wall portion US1 or the second side wall portion LS1 is spaced apart from the circuit board 112 by the minimum distance of the first gap Jx2, the deformation of the circuit board 112 caused by the accidental touch operation applied by the user can be effectively prevented, thereby effectively enhancing the operation accuracy of the earphone 10 and improving the anti-interference capability of the control function of the earphone 10. An embodiment in which the minimum distance from the inner side of the first side wall portion US1 to the circuit board 112 and the minimum distance from the inner side of the second side wall portion LS1 to the circuit board 112 are set to be the first gap Jx2 is mainly taken to describe the earphone 10 of the present disclosure in detail.

Optionally, in some embodiments, the first gap Jx2 is greater than an amount of deformation of the first side wall portion US1 and the second side wall portion LS1 when the opposing compression force F1 is a first pressure threshold, and less than an amount of deformation of the first side wall portion US1 and the second side wall portion LS1 when the opposing compression force F1 is a second pressure threshold. The first pressure threshold is not less than 0.5 newtons, and the second pressure threshold is within a range from 1 newton to 5 newtons. The first pressure threshold is a limit value of the opposing compression force F1 applied to the first side wall portion US1 and the second side wall portion LS1 caused by the accidental touch operation of the user. Therefore, by setting the first gap Jx2 to be greater than the amount of deformation of the first side wall portion US1 and the second side wall portion LS1 when the opposing compression force F1 is the first pressure threshold, the control accuracy of the earphone 10 and the anti-interference capability of the control function can be effectively improved. Furthermore, the second pressure threshold may be a minimum value capable of triggering the earphone function of the earphone 10. By setting the first gap Jx2 to be less than the amount of deformation of the first side wall portion US1 and the second side wall portion LS1 when the opposing compression force F1 is the second pressure threshold, the pressing-control comfort of the earphone 10 can be effectively improved. By setting the first pressure threshold to be not less than 0.5 newtons, the control accuracy of the earphone 10 and the anti-interference capability of the control functions can be further improved. By setting the second pressure threshold to be within the range from 1 newton to 5 newtons, the pressing-control comfort of the earphone 10 can be further improved.

Optionally, as shown in FIG. 8 and FIG. 9, in some embodiments, as described above, the housing assembly 110 includes the second housing 1102 that cooperates with the first housing 1101 along the preset cooperation direction, and the cooperation direction intersects with the spacing direction. The second housing 1102 includes a third side wall portion US2 and a fourth side wall portion LS2 that are spaced apart along the spacing direction. The third side wall portion US2 and the fourth side wall portion LS2 are inserted into a space between the first side wall portion US1 and the second side wall portion LS1 along the cooperation direction and partially overlap with the first side wall portion US1 and the second side wall portion LS1, respectively. In the natural state and along the spacing direction, the second gap Jx1 is maintained between the first side wall portion US1 and the adjacent third side wall portion US2, and the second gap Jx1 is maintained between the second side wall portion LS1 and the adjacent fourth side wall portion LS2. The second gap Jx1 is greater than the first gap Jx2. Specifically, as described above, the third side wall portion US2 and the fourth side wall portion LS2 are two side wall portions of the second housing 1102 that are spaced apart from each other along the spacing direction. The third side wall portion US2 and the fourth side wall portion LS2 are inserted into the space between the first side wall portion US1 and the second side wall portion LS1 along the cooperation direction and partially overlap with the first side wall portion and the second side wall portion, respectively. It can be understood that, after the first housing 1101 and the second housing 1102 cooperate along the cooperation direction, a portion of the third side wall portion US2 and the fourth side wall portion LS2 provided with the second annular portion 1102a is inserted into an inner side of the first annular portion 1101a and overlaps with the first annular portion 1101a. In the natural state and along the spacing direction, the second gap Jx1 is maintained between the first side wall portion US1 and the adjacent third side wall portion US2, and the second gap Jx1 is maintained between the second side wall portion LS1 and the adjacent fourth side wall portion LS2, each second gap Jx1 is greater than the first gap Jx2. It may be understood that, in the natural state and along the spacing direction, the first annular portion 1101a and the second annular portion 1102a include the second gap Jx1, i.e., the gluing gap described above. The first housing 1101 serves as a main component for receiving the opposing compression force F1 applied by a user, and the second housing 1102 abuts against the first housing 1101 along the spacing direction. Therefore, the second housing 1102 can generate a certain resistance to the deformation of the first side wall portion US1 and the second side wall portion LS1. Accordingly, by setting the second gap Jx1 to be greater than the first gap Jx2, the resistance of the second housing 1102 to the first side wall portion US1 and the second side wall portion LS1 in a deformation stroke of compressing the circuit board 112 by the first side wall portion US1 and the second side wall portion LS1 is effectively reduced, thereby ensuring that the first side wall portion US1 and the second side wall portion LS1 smoothly abut against the circuit board 112, and effectively improving the stability of the pressing-control function of the earphone 10.

Optionally, as shown in FIG. 8, in some embodiments, as described above, the first housing 1101 further includes the first top wall portion OS1 connecting the first side wall portion US1 and the second side wall portion LS1, and the second housing 1102 further includes the second top wall portion OS2 connecting the third side wall portion US2 and the fourth side wall portion LS2. The first top wall portion OS1 and the second top wall portion OS2 are disposed opposite to each other and spaced apart along the cooperation direction, and the circuit board 112 is located between the first top wall portion OS1 and the second top wall portion OS2. Along the cooperation direction, one side edge 1123 of the circuit board 112 further overlaps with the overlapping portion between the first side wall portion US1 and the third side wall portion US2, and the other side edge 1122 of the circuit board 112 further overlaps with the overlapping portion between the second side wall portion LS1 and the fourth side wall portion LS2. Specifically, as described above, along the cooperation direction, the first top wall portion OS1 is located at one end of the first side wall portion US1 and one end of the second side wall portion LS1, and is respectively connected to the first side wall portion US1 and the second side wall portion LS1. In this way, a cantilever arrangement is formed among the first side wall portion US1, the second side wall portion LS1, and the first top wall portion OS1. That is, the first side wall portion US1 and the second side wall portion LS1 are suspended on the first top wall portion OS1. Based on this, an end of the first side wall portion US1 and an end of the second side wall portion LS1 away from the first top wall portion OS1 (i.e., along the cooperation direction, an end close to the overlapping portion between the first side wall portion US1 and the third side wall portion US2 and an end close to the overlapping portion between the second side wall portion LS1 and the fourth side wall portion LS2) deform more easily. Therefore, along the spacing direction, the side edge 1123 of the circuit board 112 further overlaps with the overlapping portion between the first side wall portion US1 and the third side wall portion US2, and the other side edge 1122 of the circuit board 112 further overlaps with the overlapping portion between the second side wall portion LS1 and the fourth side wall portion LS2, so as to facilitate compressing the circuit board 112 by the first side wall portion US1 and the second side wall portion LS1, thereby effectively improving the stability of the pressing-control function of the earphone 10. Of course, in some embodiments, along the spacing direction, the two side edges (i.e., the side edge 1122 and the side edge 1123) of the circuit board 112 may also be set to have an overlapping relationship with the third side wall portion US2 and the fourth side wall portion LS2, respectively. In addition, a minimum distance between an inner side of the third side wall portion US2 and the circuit board 112 may also be set to be the first gap Jx2, and a minimum distance between an inner side of the fourth side wall portion LS2 and the circuit board 112 may also be set to be the first gap Jx2. In this way, when the first side wall portion US1 and the second side wall portion LS1 are subjected to the opposing compression force F1, the first side wall portion US1 and the third side wall portion US2 can compress the side edge 1123 of the circuit board 112, and the second side wall portion LS1 and the fourth side wall portion LS2 can compress the other side edge 1122 of the circuit board 112, thereby effectively preventing misalignment of the first side wall portion US1 and the third side wall portion US2 and misalignment of the second side wall portion LS1 and the fourth side wall portion LS2, and avoid loosening between the first housing 1101 and the second housing 1102.

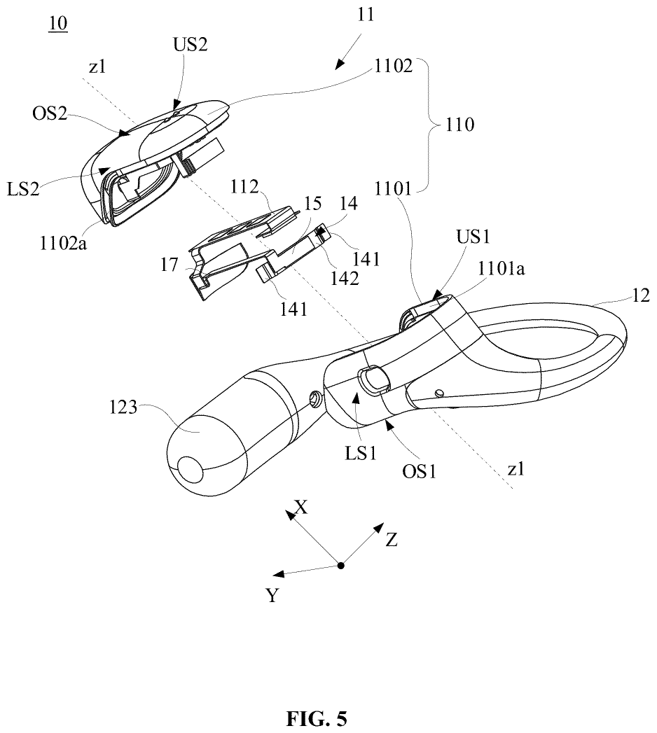

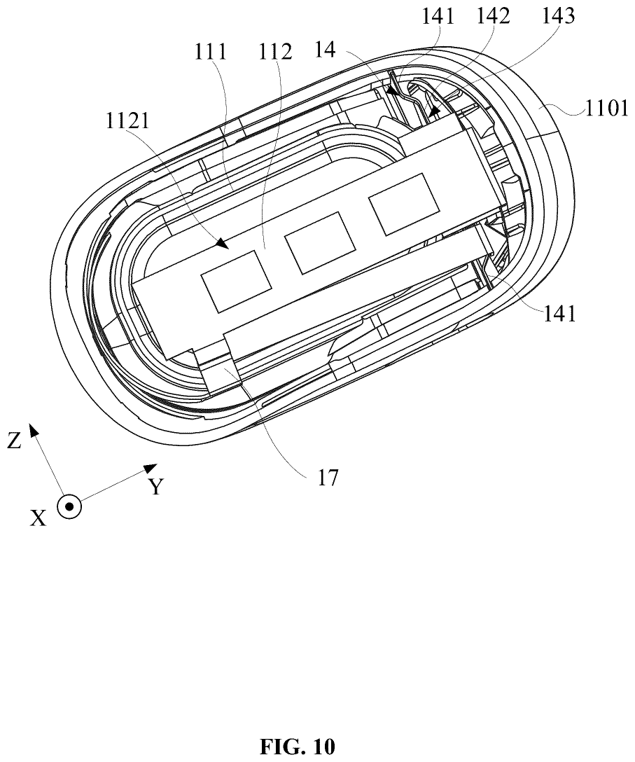

Optionally, as shown in FIG. 5 and FIG. 10, in some embodiments, as described above, the earphone 10 further includes the circuit board 112 disposed in the housing assembly 110. The deformation member 14 is separated from the circuit board 112. The circuit board 112 includes the sensing control circuit electrically connected to the sensor 15, and the sensing control circuit is configured to perform the corresponding control function based on the electrical signal. Specifically, the deformation member 14 is disposed as an independent component in the housing assembly 110, and the sensor 15 is disposed on the deformation member 14. In this way, the space occupation of the circuit board 112 by the sensor 15 can be effectively reduced, thereby reducing design complexity of the circuit board 112.

Optionally, as shown in FIG. 5 and FIG. 10, in some embodiments, along the spacing direction, the deformation member 14 includes two abutment portions 141 opposite to each other, and each of the first side wall portion US1 and the second side wall portion LS1 is provided with an abutment groove. Each of the two abutment portions 141 is disposed in one of the abutment grooves. In some embodiments, the abutment portions 141 may be fixedly connected to the abutment grooves through a dispensing manner, thereby effectively improving the connection stability between the deformation member 14 and the housing assembly 110, and ensuring the touch-control stability of the earphone 10.

Preferably, as shown in FIG. 5 and FIG. 10, the deformation member 14 further includes an arched portion 142. The two abutment portions 141 are respectively connected to two ends of the arched portion 142 and extend away from the arched portion 142 to form a complete deformation member 14. The arched portion 142 is arranged in an arch from the two ends of the arched portion 142 along a direction perpendicular to the spacing direction. The sensor 15 is disposed on the arched portion 142, and the two abutment portions 141 abut against the first side wall portion US1 and the second side wall portion LS1, respectively. Specifically, in some embodiments, along the spacing direction, the sensor 15 is located at the middle portion of the arched portion 142. In other words, along the spacing direction, at least a middle region of the arched portion 142 is set as the plate-shaped region 16, and the sensor 15 is located on the plate-shaped region 16. The arched portion 142 is arranged in an arch from two ends of the arched portion 142 along a direction perpendicular to the spacing direction. The arched portion 142 deforms when the first side wall portion US1 and the second side wall portion LS1 are subjected to the opposing compression force F1, and compresses the two abutment portions 141, so that the two abutment portions 141 compress the arched portion 142, thereby causing the deformation of the arched portion 142. In this way, when the arched portion 142 is compressed by the two abutment portions 141, the arched portion 142 can better deform, thereby effectively improving the control accuracy of the earphone 10.

Optionally, in some embodiments, the deformation member 14 is formed by bending a plate or a sheet, and the arched portion 142 is arranged in a rectangular arch shape, a U-shape, or a C-shape. Of course, in some other embodiments, the deformation member 14 may also be formed by bending a rod-shaped member, a bar-shaped member, or the like.

Optionally, as shown in FIG. 5 and FIG. 10, in some embodiments, as described above, the earphone 10 further includes the speaker 111 disposed in the housing assembly 110. The main surface 1121 of the circuit board 112 is disposed to overlap with the speaker 111 along the axial direction z1 of the speaker 111. The deformation member 14 is disposed on a side of the speaker 111 along a radial direction of the speaker 111, and a main surface 143 of the deformation member 14 and the main surface 1121 of the circuit board 112 intersect with each other. In this way, the space utilization inside the housing assembly 110 can be effectively improved. In some embodiments, a thickness of the arched portion 142 is set to be 0.2 mm, a width of the arched portion 142 is set to be 1.9 mm, and a length of the arched portion 142 is set to be 11.5 mm. The width of the arched portion 142 refers to a structural length along the axial direction z1 of the speaker 111, the length of the arched portion 142 refers to a structural length along the spacing direction, and the thickness of the arched portion 142 refers to a structural length along the length direction Y of the housing assembly 110. Optionally, in other embodiments, the main surface 1121 of the circuit board 112 and the main surface 143 of the deformation member 14 overlap with the speaker 111 along the axial direction z1 of the speaker 111 and overlap with each other. The axial direction z1 of the speaker 111 is parallel to the thickness direction X of the core module 11.

Optionally, in some embodiments, the earphone 10 further includes the ear-hook portion 12 connected to the housing assembly 110. The ear-hook portion 12 is configured to position the housing assembly 110 anterior to the user's auricle in the wearing state, and the deformation member 14 is disposed at a side of the speaker 111 near the ear-hook portion 12 along the radial direction of the speaker 111. In this way, the space utilization of the housing assembly 110 can be effectively improved.

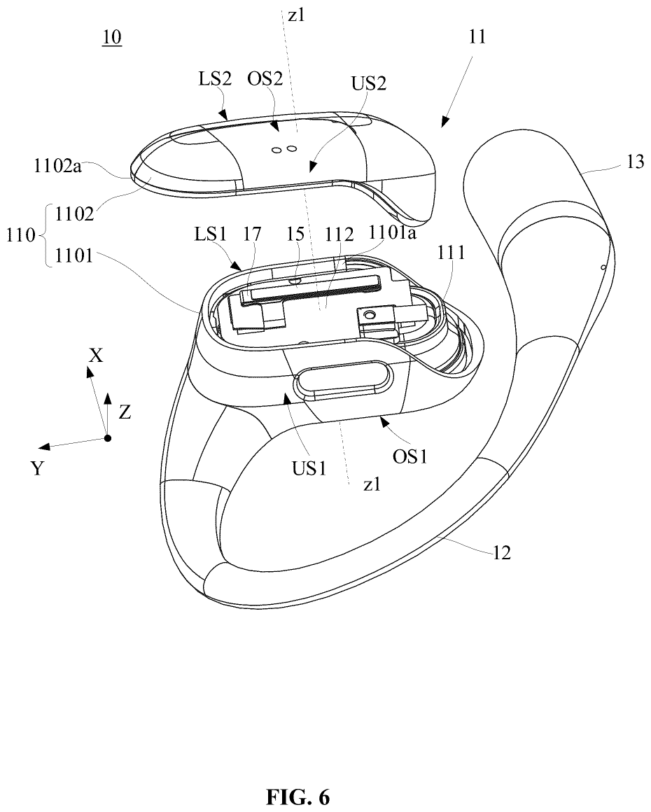

Optionally, as shown in FIG. 6 and FIG. 11, in some embodiments, the deformation member 14 may also be the second housing 1102. Specifically, the second housing 1102 includes the third side wall portion US2, the fourth side wall portion LS2, and the second top wall portion OS2. The second housing 1102 cooperates with the first housing 1101 by a manner described in the above embodiments, and the sensor 15 is disposed on the second top wall portion OS2. When the first side wall portion US1 and the second side wall portion LS1 are subjected to the opposing compression force F1 and deform, the first side wall portion US1 and the second side wall portion LS1 respectively compress the third side wall portion US2 and the fourth side wall portion LS2, so that the third side wall portion US2 and the fourth side wall portion LS2 pull the second top wall portion OS2 and cause the deformation of the second top wall portion OS2. The sensor 15 disposed on the second top wall portion OS2 generates an electrical signal after detecting the deformation of the second top wall portion OS2. The sensor 15 is electrically connected to the circuit board 112 through a flexible circuit board 17/a wire assembly, so that the electrical signal is transmitted to the main control circuit of the circuit board 112. In this way, the structure of the earphone 10 can be effectively simplified, thereby optimizing the space utilization of the earphone 10.

In addition, in some embodiments, the circuit board 112 is located between the speaker 111 and the second top wall portion OS2. In this way, the sensor 15 may be positioned as close to the circuit board 112 as possible, so that a length of the flexible circuit board 17 is reduced, thereby effectively improving the space utilization inside the housing assembly 110.

Optionally, in some embodiments, the deformation member 14 may also be a top wall of the first housing 1101, for example, the first top wall portion OS1.

The above descriptions are only a portion of embodiments of the present disclosure, and are not intended to limit the scope of the present disclosure. Any equivalent device or equivalent process transformed using the contents of the specification of the present disclosure and the accompanying drawings, or directly or indirectly applied in other related technical fields, are all included in the scope of the present disclosure.

What is claimed is:

1. An earphone, comprising:
a housing assembly including a first housing, the first housing including a first side wall portion and a second side wall portion that are disposed opposite to and spaced apart from each other;
a deformation member; and
a sensor, wherein
the deformation member is disposed between the first side wall portion and the second side wall portion;
when outer sides of the first side wall portion and the second side wall portion are subjected to an opposing compression force applied along a spacing direction between the first side wall portion and the second side wall portion, at least one of the first side wall portion or the second side wall portion deforms, and the first side wall portion and the second side wall portion jointly compress the deformation member such that the deformation member bends laterally in the spacing direction; and
the sensor is disposed in a bending region of the deformation member, and generates an electrical signal when a bending degree of the bending region is greater than a preset bending threshold.

2. The earphone of claim 1, wherein
the deformation member has a plate-shaped region;
the plate-shaped region is configured to laterally bend toward a main surface of the plate-shaped region under a compression action of the first side wall portion and the second side wall portion; and
the sensor is disposed on the plate-shaped region.

3. The earphone of claim 2, wherein
the deformation member is a circuit board;
the sensor is disposed on the circuit board;
the circuit board is provided with a sensing control circuit electrically connected to the sensor; and
the sensing control circuit is configured to perform a corresponding control function based on the electrical signal.

4. The earphone of claim 3, wherein
a main surface of the circuit board is disposed along the spacing direction;
the first side wall portion and the second side wall portion compress opposite side edges of the circuit board under an action of the opposing compression force such that the main surface of the circuit board laterally bends; and
the sensor is disposed on the main surface of the circuit board.

5. The earphone of claim 4, wherein in a natural state and along the spacing direction, a first gap is maintained between at least one of the first side wall portion or the second side wall portion and a corresponding adjacent side edge of the circuit board.

6. The earphone of claim 5, wherein
the first gap is greater than an amount of deformation of the first side wall portion and the second side wall portion when the opposing compression force is a first pressure threshold, and less than an amount of deformation of the first side wall portion and the second side wall portion when the opposing compression force is a second pressure threshold;
the first pressure threshold is not less than 0.5 newtons; and
the second pressure threshold is within a range from 1 newton to 5 newtons.

7. The earphone of claim 5, wherein
the housing assembly includes a second housing that cooperates with the first housing along a preset cooperation direction, the cooperation direction intersecting with the spacing direction;
the second housing includes a third side wall portion and a fourth side wall portion that are spaced apart along the spacing direction;
the third side wall portion and the fourth side wall portion are inserted into a space between the first side wall portion and the second side wall portion along the cooperation direction and partially overlap with the first side wall portion and the second side wall portion, respectively; and
in a natural state and along the spacing direction, a second gap is maintained between the first side wall portion and the adjacent third side wall portion, a second gap is maintained between the second side wall portion and the adjacent fourth side wall portion, each second gap being greater than the first gap.

8. The earphone of claim 7, wherein
the first housing further includes a first top wall portion connecting the first side wall portion and the second side wall portion;
the second housing further includes a second top wall portion connecting the third side wall portion and the fourth side wall portion;
the first top wall portion and the second top wall portion are disposed opposite to each other and spaced apart along the cooperation direction;
the circuit board is located between the first top wall portion and the second top wall portion; and
along the cooperation direction, one side edge of the circuit board further overlaps with an overlapping portion between the first side wall portion and the third side wall portion, and the other side edge of the circuit board further overlaps with an overlapping portion between the second side wall portion and the fourth side wall portion.

9. The earphone of claim 2, wherein
the earphone further includes a circuit board disposed in the housing assembly;
the deformation member is separated from the circuit board;
the circuit board includes a sensing control circuit electrically connected to the sensor; and
the sensing control circuit is configured to perform a corresponding control function based on the electrical signal.

10. The earphone of claim 9, wherein,
along the spacing direction, the deformation member includes two abutment portions opposite to each other,
each of the first side wall portion and the second side wall portion is provided with an abutment groove, and
each of the two abutment portions is disposed in one of the abutment grooves.

11. The earphone of claim 9, wherein,
along the spacing direction, the deformation member includes an arched portion and two abutment portions, the two abutment portions are respectively connected to two ends of the arched portion and extend away from the arched portion;
the arched portion is arranged in an arch from the two ends of the arched portion along a direction perpendicular to the spacing direction;
the sensor is disposed on the arched portion; and
the two abutment portions abut against the first side wall portion and the second side wall portion, respectively.

12. The earphone of claim 11, wherein along the spacing direction, the sensor is located at a middle portion of the arched portion.

13. The earphone of claim 11, wherein
the deformation member is formed by bending a plate or a sheet; and
the arched portion is arranged in a rectangular arch shape, a U-shape, or a C-shape.

14. The earphone of claim 11, wherein
the earphone further includes a speaker disposed in the housing assembly;
a main surface of the circuit board is disposed to overlap with the speaker along an axial direction of the speaker;
the deformation member is disposed on a side of the speaker along a radial direction of the speaker; and
a main surface of the deformation member and the main surface of the circuit board intersect with each other.

15. The earphone of claim 14, wherein
the earphone further includes an ear-hook portion connected to the housing assembly;
the ear-hook portion is configured to position the housing assembly anterior to a user's tragus in a wearing state; and
the deformation member is disposed at a side of the speaker near the ear-hook portion along the radial direction of the speaker.

16. The earphone of claim 11, wherein
the earphone further includes a speaker disposed in the housing assembly; and
a main surface of the circuit board and a main surface of the deformation member overlap with the speaker along an axial direction of the speaker, and overlap with each other.

17. The earphone of claim 2, wherein
the deformation member serves as a first top wall portion of the first housing that connects the first side wall portion and the second side wall portion; or
the deformation member serves as a second housing cooperating with the first housing.

18. The earphone of claim 1, wherein
the housing assembly further includes a second housing cooperating with the first housing;
the earphone further includes a speaker disposed in the housing assembly and an ear-hook portion connected to the housing assembly;
the ear-hook portion is configured to position the housing assembly anterior to a user's tragus in a wearing state; and
the speaker is substantially or entirely located within the first housing.

19. The earphone of claim 18, wherein
the housing assembly includes a connection end connected to the ear-hook portion and a free end away from the connection end;
the housing assembly has a length direction, a width direction, and a thickness direction that are orthogonal to each other, wherein the length direction is defined as a direction from the free end toward or away from the connection end, and the thickness direction is defined as a direction toward or away from the user's auricle in the wearing state; and
the first side wall portion and the second side wall portion are spaced apart from each other along the width direction.

20. The earphone of claim 19, wherein a dimension of the first side wall portion along the length direction is greater than a dimension of the first side wall portion along the thickness direction, and a dimension of the second side wall portion along the length direction is greater than a dimension of the second side wall portion along the thickness direction.
